(19) United States
(12) Patent Application Publication
(10) Pub. No.: US 2019/0226856 A1
(43) Pub. Date: Jul. 25, 2019

(54) WILDFIRE DISCOVERY, MONITORING, AND RESPONSE SYSTEM USING PERSONAL VEHICLES

(71) Applicant: FORD GLOBAL TECHNOLOGIES, LLC, DEARBORN, MI (US)

(72) Inventors: Mahmoud Y. Ghannam, Canton, MI (US); Brian Bennie, Sterling Heights, MI (US); Steven Y. Schondorf, Dearborn, MI (US)

(21) Appl. No.: 15/877,678

(22) Filed: Jan. 23, 2018

(51) Int. Cl. G01C 21/34; G08G 1/0967; G08G 1/0968; G08B 17/00; G07C 5/00

(52) U.S. Cl. CPC G01C 21/3415; G01C 21/3461; G07C 5/008; G08G 1/0968; G08B 17/005; G08G 1/0967

(57) ABSTRACT

A distributed system detects and tracks wildfires using a fleet of automobiles as remote sensing systems. An individual vehicles includes a plurality of sensing subsystems each collecting and evaluating a respective environmental parameter for various autonomous functions such as collision avoidance, lane-keeping, and climate control. Each sensing subsystem analyzes a respective environmental parameter to detect a respective fire-related trigger. A fire response module in the vehicle responds to a respective fire-related trigger from one of the sensing subsystems by fusing data from a plurality of the sensing subsystems. The fire response module uses the fused data to detect whether there is a fire-related event. A wireless communication module communicates with a remote fire response center, and transmits the fused data to the fire response center when a fire-related event is detected. The response center sends notices and detour information for a confirmed fire incident to the wireless communication module.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to wildfire detection, tracking, and response systems, and, more specifically, to onboard vehicle systems for gathering data characterizing potential fire events, for sharing the data, and for safely navigating away from confirmed fire events.

Wildfires in forests and other natural areas are a well-recognized problem which have been increasing in frequency, duration, and intensity throughout the world. Current wildfire detection efforts have been based on dedicated ground-based visual and non-visual sensors in fixed locations or driven on customized vehicles as specialized instrument packages. Instruments are also deployed in aircraft and satellites. Known systems have exhibited various shortcomings, such as, reliance on human intervention, relatively limited coverage, and very high cost.

### SUMMARY OF THE INVENTION

Personal automotive vehicles are becoming smarter and more autonomous. Supporting this trend, they typically carry many different types of sensors for monitoring/measuring various local environmental parameters such as air temperature, air pressure, relative movement of nearby objects, and surrounding images (optical and infrared). The use of wireless communication between a vehicle and infrastructure (e.g., the Internet or Cloud) and between a vehicle and other nearby vehicles is also becoming widespread. Consequently, vehicles can be configured to help detect fires, provide warnings, and implement responses.

This invention provides an early fire detection method utilizing scattered vehicles as a “net of mobile nodes.” It enhances fire-fighting by enabling low cost and pervasive data gathering to support the determination of fire location, size, direction, and estimated burn rates. It helps mitigate the risk and cost of wildfires by detecting a fire event while it is in a more controllable state. It shares information with vehicles in the region of the fire so they can take action, such as additional data gathering and detouring around any confirmed wildfires.

In preferred embodiments, 360-degree visible cameras, infrared cameras, Radar, and/or LiDAR sensing subsystems on a car capture surrounding images and process them for various assisted driving features. The various vehicle control subsystems record the images or other environmental parameters and, in addition to their vehicle control functions, examine them for a potential indication of a fire (e.g., using pattern recognition to examine the shape, strength, and source of a possible fire). When at least one sensing subsystem is triggered as detecting a potential fire event, a central onboard logic system collects relevant data from a plurality of sensing subsystems so that it can analyze the parameters (e.g., by classifying the images whether they show fire flames or smoke plumes using pattern-recognition software and by making other comparisons). Depending on the results, the data may be transmitted to a remote fire response center (i.e., monitoring station) for further analysis and actions. This vehicular-based sensing approach provides continuous monitoring in more areas simultaneously and enables an ability to send/display warnings locally to paired smart devices and remotely (cloud-based) to nearby vehicles and to the response center through V2X communication links. The invention also enables vehicles to quickly alter their routes if possible to avoid rapidly moving fires.

In one aspect of the invention, vehicular apparatus comprises a plurality of sensing subsystems in a vehicle each collecting and evaluating a respective environmental parameter. Each sensing subsystem analyzes a respective environmental parameter to detect a respective fire-related trigger. A fire response module is coupled to the sensing subsystems which responds to a respective fire-related trigger from one of the sensing subsystems by fusing data from a plurality of the sensing subsystems. The fire response module is responsive to the fused data to detect whether there is a fire-related event. A wireless communication module is adapted to communicate with a remote fire response center, wherein the communication module transmits the fused data to the fire response center when the fire-related event is detected. The communication module receives from the fire response center notices and routing information for navigating away from a confirmed fire incident.

### BRIEF DESCRIPTION OF THE DRAWINGS

FIG. 1 is a diagram showing distributed elements of a wildfire detection and response system according to one preferred embodiment of the invention.

FIG. 2 is a block diagram showing an onboard vehicle system including a fire response module.

FIG. 3 is a flowchart showing one preferred method of the invention.

FIG. 4 is an image from a camera system with visible flame and smoke.

FIG. 5 is a block diagram showing one embodiment for detecting a fire-related trigger.

FIG. 6 is a diagram showing a spotting location.

FIG. 7 is a functional block diagram including a fire response center and emergency response assets.

### DETAILED DESCRIPTION OF PREFERRED EMBODIMENTS

In some embodiments, vehicle image sensing and recognition systems detect the presence of smoke and/or fire, e.g., using the visible light spectrum of 360-degree cameras. These onboard systems have the advantage of continuous operation, relative proximity to potential sources of wildfires, and can support ongoing operations even after a fire is initially detected (e.g., in response to follow-up requests for data received from a response center). Using V2V networks for data transmission between vehicles (which remains stable even in remote areas), more extensive data sets with multiple camera images from multiple viewing locations and directions can confirm each other, which increases the robustness of discriminating smoke and flame. Moreover, the sensing subsystems and vehicle communication systems can execute the monitoring and signaling tasks without direct human intervention.

Given that GPS navigation systems are deployed as a standard feature in many vehicles that may be in use at any one time over a wide region that covers areas around homes, power and communication lines, forests, and other natural areas, data from those vehicles can be fused with geographic metadata so that it can be correlated and used to obtain a consolidated assessment of fire conditions of the region. The resulting vehicle fleet configured with the invention provides a network of “alarms” that provides geographic coordinates and the size, speed, and direction of spread for fire events without human interpretation or intervention. The invention takes advantage of sensors (e.g., thermal sensors and cameras) that are already mounted on vehicles in order to monitor for potential fires. For example, external air temperature changes may indicate that heat or flame is present. Some vehicles may be equipped with infrared light cameras or sensing systems that can be used to remotely detect heat sources. Echo-return remote sensing systems such as Radar and LiDAR can be used to monitor fire, but not smoke, by sensing heat and flame through blocked conditions including fog and heavy rain that can cause issues for some image monitoring systems.

For final confirmation of the existence of a fire-related event, the onboard fire monitoring system can fuse the data outputs of the separate sensing subsystems for more rigorous onboard and offboard evaluation. Offboard transmission of data for centralized evaluation can also be requested remotely (i.e., when onboard systems have not yet detected a preliminary indication of a possible fire) or initiated automatically when a vehicle happens to be passing through special spotting locations (e.g., at a particularly significant vantage point overlooking a large landscape or at a place particularly prone to fires). Thus, the invention delivers a vehicular-based mobile fire detection network that covers large areas on a 24-hour basis with minimum cost and unmanned operation. It is also well suited for “post fire” assessments of damage and for spotting fires during different weather conditions.

The overall cost is low for this network because vehicles already are equipped with the required sensing systems and the necessary wireless communication capability already exists. Since a high rate of traffic may often exist along areas needing surveillance, a high data sampling rate and an availability of the data over the Cloud and to a central response station is obtained, thereby providing substantially continuous views and data interpretation to support detection.

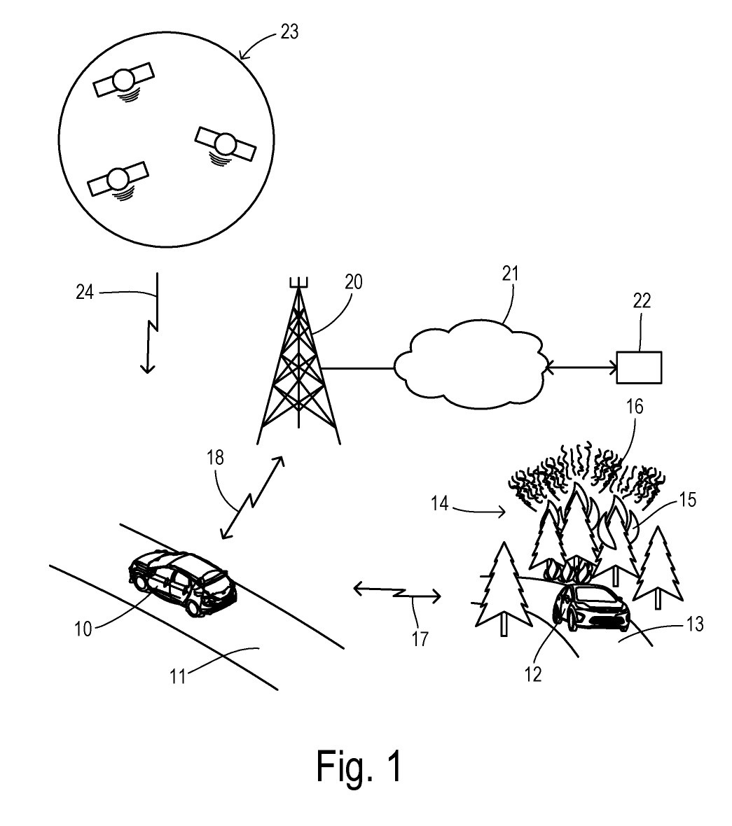

Referring to FIG. 1, a vehicle 10 traversing a roadway 11 and a vehicle 12 traversing a roadway 13 are each equipped with vehicle apparatus for practicing the fire detection and response functions of the present invention. Vehicle 12 is being driven in an area where a wildfire 14 is producing visible flames 15 and smoke plumes 16. Vehicles 10 and 12 are equipped for wireless communication via vehicle-to-everything (V2X) systems, as well known in the art. In a preferred embodiment, communication can be provided by a vehicle-to-vehicle (V2V) communication channel 17 between vehicles 10 and 12 and by a vehicle-to-infrastructure (V2I) communication channel 18 between vehicle 10 and a base station 20. Base station 20 is connected via a cloud network 21 to a remote fire response center 22. In addition, a GPS satellites 23 provide GPS signals via a GPS channel 24 to GPS navigation system receivers in vehicles 10 and 12 in the conventional manner.

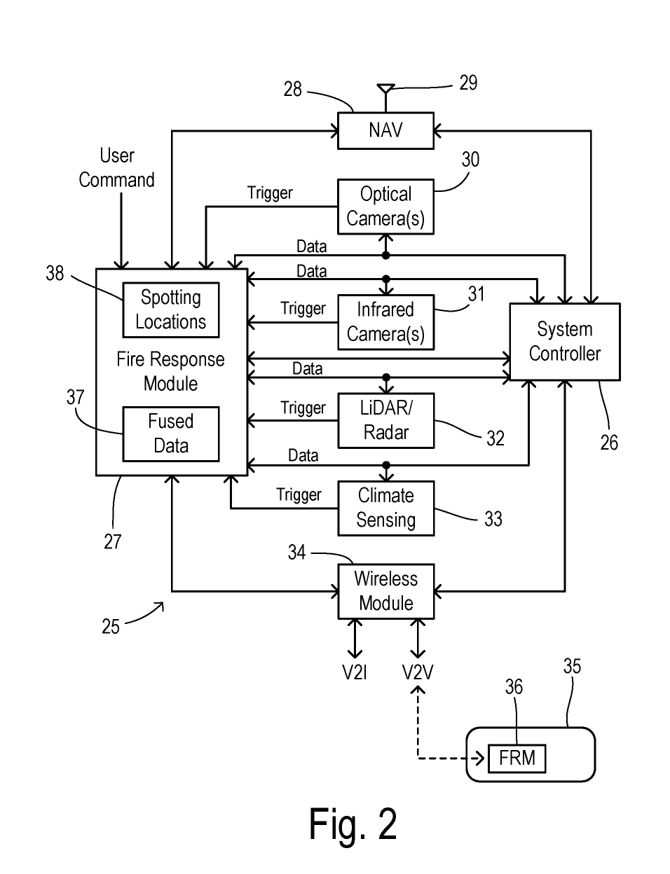

Relevant portions of the electronics and control systems in an individual vehicle are shown in FIG. 2. Vehicle apparatus 25 includes a main system controller 26 interconnected with a fire response module 27, a navigation module 28, and a wireless communication module 34. In a typical embodiment, each of the separate modules or subsystems shown in apparatus 25 are interconnected by a multiplex bus for transmitting various control and data signals between separate modules on the multiplex network. System controller 26 and/or fire response module 27 can be implemented in one or more electronic circuit modules and microcontrollers as known in the art. Navigation subsystem 25 includes antenna 29 for receiving GPS satellite signals which are used to determine the geographic coordinates where the vehicle is located.

A plurality of sensing subsystems in the vehicle apparatus 25 collect and evaluate respective environmental parameters as part of performing various driver assist functions or other vehicle accessory functions. The sensing subsystems include an optical camera 30 which may be part of an obstacle detection system or a backup camera system as known in the art. Camera subsystem 30 is coupled to system controller 26 and to fire response module 27 for receiving command control signals and supplying environmental parameter in the form of camera images, for example. Optical camera is 30 is further connected to fire response module 27 for providing a respective fire related trigger as discussed below.

An infrared camera subsystem 31 may also present in the vehicle as part of an object detection system capable of gathering data under low visible light conditions, for example. Infrared camera subsystem 31 also provides signal processing which is able to examine environmental parameters in the form of infrared images to detect a respective fire related trigger (such as a concentration of high intensity infrared indicative of fire). A resulting trigger signal is provided to fire response module 27.

Another sensing subsystem may be a remote sensor comprised of a LiDAR or Radar sensing subsystem 32 for sending out light or radio pulses, respectively, and detecting echo returns in order to identify and track remote objects near the vehicle such, e.g., as part of an adaptive cruise control system. Subsystem 32 analyzes returned echoes as the environmental parameter for detecting a respective fire related trigger.

Another sensing subsystem that can be utilized in the invention includes a climate sensing subsystem 33 which measures external air temperature, external air pressure, external air humidity, and/or air quality (such as detecting smoke particles). Climate sensing subsystem 33 is likewise coupled via the multiplex bus to system controller 26 for receiving command signals and to fire response module 27 to transmit environmental parameters or a trigger signal when the environmental parameters suggest the possibility of a fire-related event.

Wireless communication module 34 is connected via the multiplex bus to system controller 26 and fire response module 27. It configured to conduct vehicle-to-vehicle communication with another vehicle 35 which contains its own fire response module 36. The separate vehicles can share data, warning messages, request messages, and route detour information, for example.

Fire response module 27 preferably includes a memory 37 for storing fused data from some or all of the sensing subsystems. Fused data may preferably include a plurality of measured environmental parameters from the sensing subsystems which are relevant to detecting whether there is a fire-related event. Preferably, the fused data may also include geographic metadata such as the vehicle location when the environmental parameters were respectively obtained and/or a geographic direction inherent in the environmental parameter (e.g., the direction in which a particular image was captured).

Fire response module 27 maintains a database 38 of spotting locations that can be utilized to initiate transmission of the fused data to a response center as explained below. Alternatively, a spotting location database can be located remotely (with the vehicle remotely transmitting its geographic coordinates to the cloud for comparison with the spotting locations). Fire response module 27 is also connected to receive user (e.g., driver) commands which are manually generated on a user interface and can be used to initiate transmission of the fused data in the event that the user notices fire or smoke. The user interface can include a touchscreen display in the vehicle or a paired smartphone, for example. For a parked vehicle, a remote command from a wireless device could wake-up the system electronics so that fused data could be obtained from an unattended vehicle.

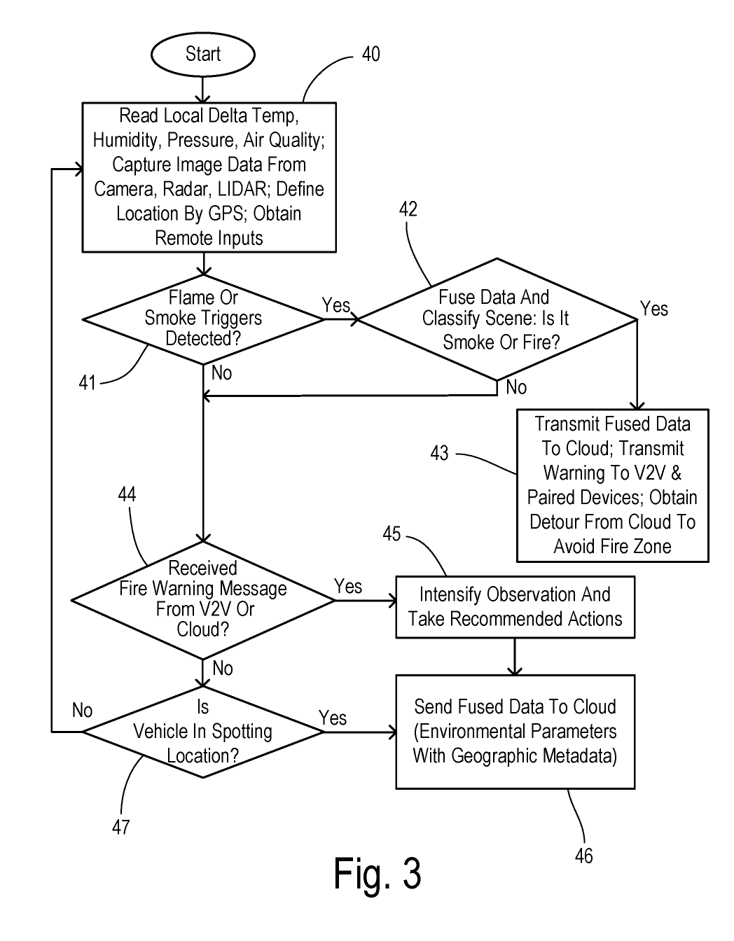

A preferred operational method of the invention is shown in FIG. 3. The method may run continuously when a vehicle is in an ON or Run state. It might also be started when the vehicle is in an OFF state in response to a remote wake-up command. In step 40, the sensing subsystems read respective environmental parameters such as local exterior temperature differences, humidity, pressure, and air quality sensed by a climate control subsystem. Provided they are present in the vehicle, additional subsystems capture respective parameters such as images in a visible light camera and/or an infrared camera, and echo return remote-sensing data such as from a Radar or LiDAR subsystem which collects such parameters for performing their existing functions including obstacle detection, lane-keeping, autonomous cruise control, emergency braking, and others. A geographic location is also continually monitored via GPS in step 40. Using the wireless communication system, the fire response module continuously monitors for remote inputs including requests for data, fire warning messages, and recommended detours (e.g., routing segments) for re-routing in the vicinity of any detected fire incidents.

In step 41, each separate subsystem examines its particular environmental parameters and compares them to corresponding triggers which may identify the potential presence of flame or smoke in the vicinity of the vehicle. Whenever any one of the sensing subsystems detects a respective fire-related trigger after evaluating its environmental parameters, then environmental parameters from a plurality of the sensing subsystems are gathered in step 42 by the fire response module. The fused data from the various subsystems is used in step 42 to classify a particular scene around the vehicle in order to determine whether a fire-related event is actually detected. In particular, in order to reduce overall processing capacity of the modules, the triggers used by the separate sensing subsystems may be calibrated to use a more easily satisfied threshold in detecting the possibility of fire, while the classification and detection performed by the fire response module in step 42 provides a more rigorous standard in order to provide higher reliability and detection of the fire-related event. If smoke or fire are detected in step 42 then the fused data is transmitted in step 43 to the cloud infrastructure such as a governmentally-operated fire response center. The response center has available to it not only the data from this particular vehicle but from others within the same geographic area. In step 43, the individual vehicle may also transmit a fire warning message to nearby vehicles and/or to paired Bluetooth devices such as users' smartphones to alert them to the fire danger. In addition, the individual vehicle may attempt to obtain a routing detour in step 43 from the cloud-based remote fire response center in order to safely exit the fire zone.

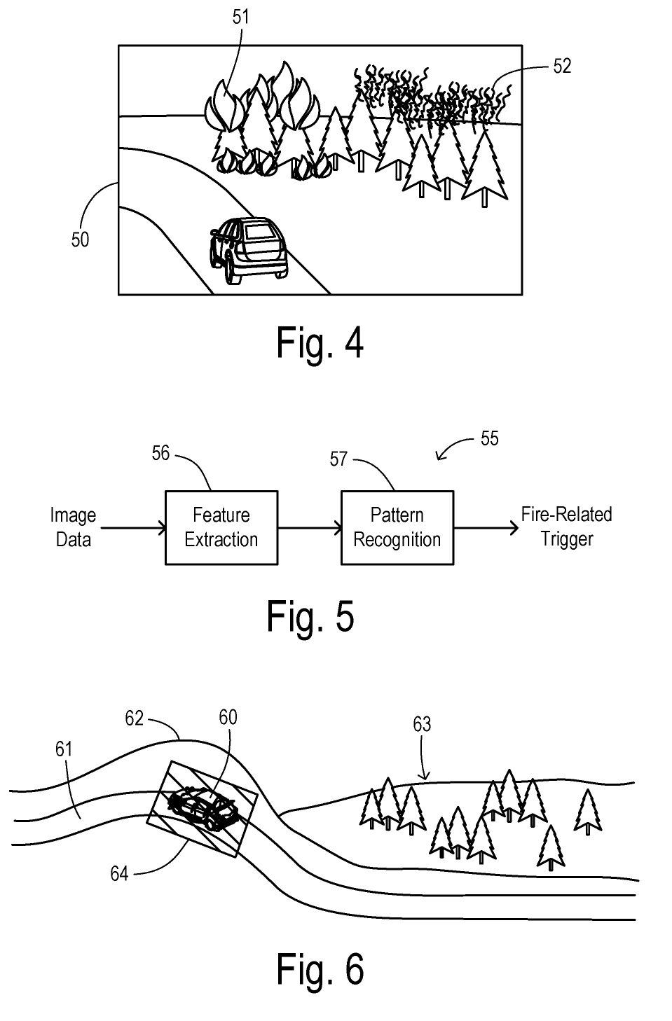

An example of classifying particular environmental parameters in the form of an optical image is shown in FIGS. 4 and 5. Different versions of this method can be calibrated for use in the sensing subsystem for triggering an initial possibility of fire or for use in the fire response module to more robustly classify the scene to obtain an actual detection. FIG. 4 shows an image 50 captured by a camera subsystem. Image 50 includes a view containing fire flames 51 and smoke plumes 52. In addition, other elements may be present such as roadways, vehicles, and other fire-free areas. As shown by a detection circuit 55 in FIG. 5, the image data may first be provided to a feature extraction block 56 for modifying image data in order to enhance features indicative of fire or smoke (e.g., changing contrast or emphasizing certain colors). Next, the image data is analyzed using a pattern recognition block 57 to scan the image data for characteristics indicative of fire such as color, intensity, and movement of detected features between successively captured images. Detector 55 provides an output signal which can be the fire-related trigger if used in a sensing subsystem or can be an actionable detection of fire or smoke if used in the fire response module.

If fire or smoke are not detected in step 42, then the method proceeds in step 44 to determine whether it has received a fire warning message from either a nearby vehicle or from the fire response center via the cloud. Thus, when a response center has determined (based on data from other vehicles or other sources of information) that a fire may be in the vicinity, then the extent of that fire may be investigated by requesting fused data from other vehicles known to be close to the possible fire. If such a message was received in step 44 then the collection and fusing of the environmental parameter data may be intensified in step 45 in the individual vehicle. Furthermore, the vehicle may take any recommended actions received with the warning/request messages such as including a recommended detour contained in a message into its selected route which is being provided to the driver for route guidance by the navigation system. In step 46, the intensified and newly fused data is sent to the cloud as requested.

A user command manually triggering the wildfire monitoring system would also result in transmission of the fused data. Thus, step 44 could also check for the user command. In the case that the vehicle was in the OFF state, the method could proceed from step 40 directly to step 46, for example.

If no warning message was received in step 44, then a check is performed in step 47 to determine whether the vehicle has moved into a predetermined spotting location. If so then fused data may be sent to the cloud in step 46. Otherwise, a return is made to step 44 continue parameter data collection and monitoring. FIG. 6 shows an example of predetermined spotting locations which can provide particularly useful views over areas that are continually monitored for the presence of fires. Thus, a vehicle 60 traveling along a roadway 61 is traversing an elevated area 62 overlooking a critical wooded area 63. Geographic data is maintained in the fire response module or in the fire response center identifying a predetermined location 64 as a spotting location. Vehicle 60 monitors its location and compares it to a database of coordinates for spotting locations. When it finds a match with the predetermined spotting location 64 then it automatically provides its fused sensor data to the fire response center.

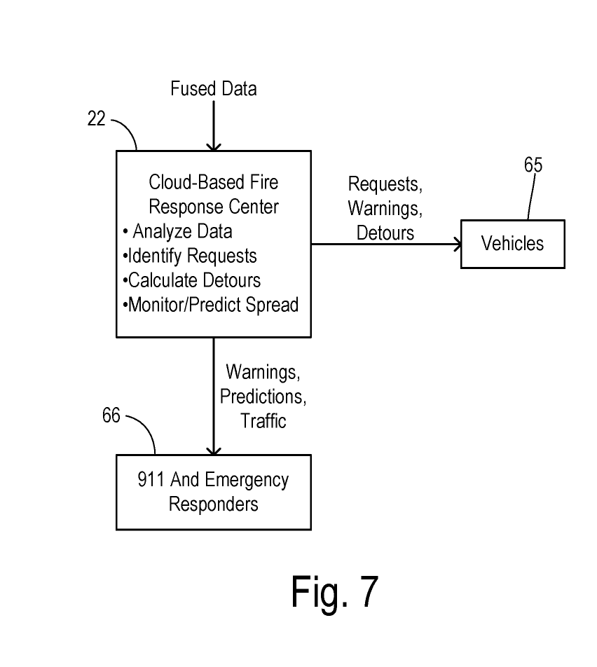

FIG. 7 depicts cloud-based fire response center 22 receiving fused data and performing various functions and interactions with a fleet of vehicles 65 and other assets such as 911 centers and emergency responders 66. Fire response center 22 analyzes fused data to compile a larger picture of the conditions in particular areas subject to wildfires. When additional data is needed, response center 22 identifies appropriate requests for vehicles within vehicle fleet 65 currently traversing the desired locations, and sends the requests. Based on the available data, the location and severity of fire incidents are detected. Warnings are sent to vehicles in fleet 65 together with calculated routing detours. Besides monitoring to detect the onset of fires, fire response center 22 uses the gathered data to predict potential spreading of fires in order to coordinate a response, including emergency response action from providers 66 and optimizing traffic flow away from areas where a detected fire is likely to spread.

What is claimed is:

1. Vehicle apparatus comprising:
a plurality of sensing subsystems in a vehicle each collecting and evaluating a respective environmental parameter, wherein each sensing subsystem analyzes a respective environmental parameter to detect a respective fire-related trigger;
a fire response module coupled to the sensing subsystems, wherein the fire response module is responsive to a respective fire-related trigger from one of the sensing subsystems to fuse data from a plurality of the sensing subsystems and is responsive to the fused data to detect whether there is a fire-related event; and
a wireless communication module adapted to communicate with a remote fire response center, wherein the communication module transmits the fused data to the fire response center when the fire-related event is detected, and wherein the communication module receives from the fire response center notices and routing information for navigating away from a confirmed fire incident.

2. The vehicle apparatus of claim 1 wherein the wireless communication module is adapted to receive a request message from the fire response center and to transmit the fused data to the fire response center in reply to the request message regardless of detection of a fire-related event.

3. The vehicle apparatus of claim 1 wherein the wireless communication module is adapted to communicate with fire response modules in other vehicles via a vehicle-to-vehicle communication system, and wherein the wireless communication module is adapted to receive a warning message from the other vehicles and to transmit the fused data to the fire response center in reply to the warning message.

4. The vehicle apparatus of claim 1 further comprising:
a navigation system for monitoring geographic location of the vehicle and detecting presence of the vehicle at a predetermined spotting location;
wherein the wireless communication module is adapted to transmit the fused data to the fire response center in response to detecting presence at the predetermined spotting location.

5. The vehicle apparatus of claim 1 wherein each sensing subsystem senses the respective environmental parameter in support of a non-fire-related vehicle operating function, and wherein the sensing subsystems include a visible light camera.

6. The vehicle apparatus of claim 1 wherein each sensing subsystem senses the respective environmental parameter in support of a non-fire-related vehicle operating function, and wherein the sensing subsystems include an infrared camera.

7. The vehicle apparatus of claim 1 wherein each sensing subsystem senses the respective environmental parameter in support of a non-fire-related vehicle operating function, and wherein the sensing subsystems include an echo-return remote sensing system.

8. The vehicle apparatus of claim 1 wherein each sensing subsystem senses the respective environmental parameter in support of a non-fire-related vehicle operating function, and wherein the sensing subsystems include an exterior climate system for sensing at least one of an air temperature, air pressure, air humidity, or air contamination.

9. The vehicle apparatus of claim 1 wherein the fused data includes geographic metadata associated with respective environmental parameter data.

10. The vehicle apparatus of claim 1 further comprising:
a navigation system for presenting route guidance to a driver of the vehicle along a selected route;
wherein the wireless communication module is adapted to receive a fire warning message including a recommended detour; and
wherein the navigation system incorporates the recommended detour into the selected route.

11. A vehicular fire sentry method comprising:
sensing a plurality of environmental parameters around a vehicle;
evaluating each environmental parameter to detect respective fire-related triggers;
fusing data corresponding to the environmental parameters and geographic metadata;
transmitting the fused data to a remote fire response center when i) a respective trigger is detected, ii) a request is received from the response center, or iii) the vehicle moves to a predetermined spotting location.

12. The method of claim 11 wherein the vehicle includes a plurality of sensing subsystems, each subsystem collecting and evaluating a respective environmental parameter.

13. The method of claim 12 wherein the vehicle includes a fire response module, and wherein the method further comprises:
the fire response module collecting the environmental parameters from the sensing subsystems in response to detection by a respective sensing subsystem of a respective trigger; and
the fire response module evaluating the collected environmental parameters to detect a fire-related event;
wherein transmitting the fused data to the remote fire response center further depends on a detection of the fire-related event.

14. The method of claim 12 wherein the vehicle includes a navigation system for presenting route guidance to a driver of the vehicle along a selected route, and wherein the method further comprises:
receiving a fire warning message including a recommended detour from the remote fire response center; and
incorporating the recommended detour into the selected route.

15. The method of claim 12 wherein the vehicle includes a navigation system, and wherein the method further comprises:
determining a geographic location of the vehicle;
comparing the geographic location to a predetermined spotting location;
collecting and transmitting the fused data to the remote fire response center when the geographic location matches the predetermined spotting location.

16. The method of claim 12 further comprising:
communicating with fire response modules in other vehicles via a vehicle-to-vehicle communication system;
receiving a warning message from one of the other vehicles; and
collecting and transmitting the fused data to the remote fire response center in reply to the warning message.

17. The method of claim 12 wherein the sensing subsystems include an infrared camera.

18. The method of claim 12 wherein the sensing subsystems include an echo-return remote sensing system.

19. The method of claim 12 wherein the sensing subsystems include an exterior climate system for sensing at least one of an air temperature, air pressure, air humidity, or air contamination.

20. The method of claim 11 wherein the fused data includes geographic metadata associated with respective environmental parameter data.
